(19) United States
(12) Patent Application Publication
(10) Pub. No.: US 2025/0341981 A1
(43) Pub. Date: Nov. 6, 2025

(54) METHOD FOR SYSTEM ON CHIP, AND RELATED PRODUCT THEREOF

(71) Applicant: Cambricon (Xi'an) Semiconductor Co., Ltd., Xi'an (CN)

(72) Inventors: Xiangxuan GE, Xi'an (CN); Yao ZHANG, Xi'an (CN); Jun LIANG, Xi'an (CN)

(21) Appl. No.: 18/681,650

(22) PCT Filed: Aug. 8, 2022
(86) PCT No.: PCT/CN2022/110739

§ 371 Date: Sep. 26, 2024

(30) Foreign Application Priority Data
Aug. 12, 2021 (CN) 202110926716.4

(51) Int. Cl. G06F 3/06

(52) U.S. Cl. CPC G06F 3/0655; G06F 3/0604; G06F 3/0673

(57) ABSTRACT

The present disclosure relates to a method for a system on chip, the system on chip, an integrated circuit device, a board card, and a computing apparatus, where the computing apparatus is included in a combined processing apparatus that further includes an interface apparatus and other processing apparatus. The computing apparatus interacts with other processing apparatus to jointly complete a user specified computation operation. The combined processing apparatus further includes a storage apparatus. The storage apparatus is connected to the computing apparatus and other processing apparatus, respectively. The storage apparatus is used to store data of the computing apparatus and other processing apparatus.

### CROSS REFERENCE OF RELATED APPLICATION

The present application claims priority to Chinese Patent Application No. 202110926716.4 with the title of “METHOD FOR SYSTEM ON CHIP, AND RELATED PRODUCT THEREOF” filed on Aug. 12, 2021.

### TECHNICAL FIELD

The present disclosure generally relates to the field of chip design technology. More specifically, a scheme of the present disclosure relates to a method for a system on chip, the system on chip, an integrated circuit device, a board card, and a computing apparatus.

### BACKGROUND

System on Chip (“SoC”) is a micro system that integrates key components for information processing on a single chip, which constitutes a System on Chip. The micro system typically includes a variety of units such as a microprocessor, an analog IP core, a digital IP core, and a memory (or an off-chip memory control interface) integrated on a single chip. In order to realize high-speed access to information (including various types of data and instructions) by a processor core, a cache, such as a first-level cache, a second-level cache, up to the last-level cache (abbreviated as “LLC”) furthest away from the processor core is usually set in the SoC. Although there are various implementations of how to use a cache efficiently at present, the use of cache under a multi-core architecture has not been fully expanded and applied. Therefore, how to fully utilize the cache of the SoC to adapt to application scenarios of the multi-core architecture becomes a technical problem to be solved.

### SUMMARY

In order to solve at least the above mentioned problem, the present disclosure proposes a scheme of using a cache to perform operations on clusters and inter-clusters. In an exemplary implementation scenario of the present disclosure, each cluster may be viewed as a collection consisting of a plurality of processor cores in the SoC. These processor cores (or computing units) may be configured to perform computational jobs including various types of operations in the field of artificial intelligence. In order to achieve efficient utilization of the cache of the SoC, the present disclosure provides, in various aspects, the following technical solutions.

A first aspect of the present disclosure provides a method used for the SoC, where the SoC includes at least a plurality of clusters for performing operations and a cache interconnected with the plurality of clusters, where each cluster includes a plurality of processor cores for performing the operations. The method includes: using partial storage space of the cache as a cluster memory; and using the cluster memory to perform operations of the cluster.

A second aspect of the present disclosure provides an SoC, which includes a plurality of clusters, where each cluster includes at least a plurality of processor cores used for performing operations, a cache interconnected with the plurality of clusters, where the cache is configured to use partial storage space as a cluster memory according to a request from the cluster, and use the cluster memory to perform operations of the cluster.

A third aspect of the present disclosure provides an integrated circuit apparatus including the SoC described above and in detail below.

A fourth aspect of the present disclosure provides a board card including the integrated circuit apparatus described above and in detail below.

A fifth aspect of the present disclosure provides a computing device including the board card described above and in detail below.

By means of the scheme described in the above multiple aspects, those skilled in the art may make different settings for the cache, so that the use of the cache may be effectively extended, allowing the cache to be fully utilized in the SoC. Further, by setting up the cluster memory for performing cluster operations in the cache, the efficient information transfer among clusters is promoted, and the overall performance of the SoC is significantly improved. In addition, by utilizing the cluster memory of the present disclosure, a cache hit rate for data access may also be substantially increased.

### BRIEF DESCRIPTION OF DRAWINGS

By reading the following detailed description with reference to accompanying drawings, the above-mentioned and other objects, features and technical effects of exemplary embodiments of the present disclosure will become easy to understand. In the accompanying drawings, several embodiments of the present disclosure are shown in an exemplary but not restrictive manner, and the same or corresponding reference numerals indicate the same or corresponding parts of the embodiments.

FIG. 1 is a structural diagram of a board card according to an embodiment of the present disclosure.

FIG. 2 is a structural diagram of an integrated circuit device according to an embodiment of the present disclosure.

FIG. 3 is a schematic diagram of an internal structure of a single-core computing device according to an embodiment of the present disclosure.

FIG. 4 is a schematic diagram of an internal structure of a multi-core computing device according to an embodiment of the present disclosure.

FIG. 5 is a schematic diagram of an internal structure of a processor core according to an embodiment of the present disclosure.

FIG. 6 is an architecture diagram of an SoC according to an embodiment of the present disclosure.

FIG. 7 is a flowchart illustrating a method for the SoC according to an embodiment of the present disclosure.

FIG. 8 is a schematic diagram illustrating communication among clusters according to an embodiment of the present disclosure.

FIG. 9 is a schematic diagram illustrating broadcasting among clusters according to an embodiment of the present disclosure.

### DETAILED DESCRIPTION OF EMBODIMENTS

Technical solutions in embodiments of the present disclosure will be described clearly and completely hereinafter with reference to the drawings in the embodiments of the present disclosure. Obviously, the embodiments to be described are merely some rather than all embodiments of the present disclosure. All other examples obtained by those skilled in the art based on the embodiments of the present disclosure without creative efforts shall fall within the protection scope of the present disclosure.

It should be understood that terms such as “first”, “second”, and “third” in the claims, the specification, and the drawings are used for distinguishing different objects rather than describing a specific order. It should be understood that terms “including” and “comprising” used in the specification and the claims indicate the presence of a feature, an entity, a step, an operation, an element, and/or a component, but do not exclude the existence or addition of one or more other features, entities, steps, operations, elements, components, and/or collections thereof.

It should also be understood that terms used in the specification of the present disclosure are merely intended to describe specific embodiments rather than to limit the present disclosure. As being used in the specification and the claims of the disclosure, unless the context clearly indicates otherwise, singular forms “a”, “an”, and “the” are intended to include plural forms. It should also be understood that a term “and/or” used in the specification and the claims refers to any and all possible combinations of one or more of relevant listed items and includes these combinations.

As being used in this specification and the claims, a term “if” may be interpreted as “when”, or “once”, or “in response to a determination” or “in response to a case where something is detected” depending on the context. Similarly, phrases such as “if . . . is determined” or “if [the described conditions or events] are detected” may be interpreted as “once . . . is determined”, “in response to determining”, “once [the described conditions or events] are detected”, or “in response to detecting [the described conditions or events]”.

In order to make full use of the data residency function of the cache, the scheme of the present disclosure proposes a method for configuring partial storage space of the cache as a cluster memory for communication between the clusters of the SoC. In an embodiment, the foregoing configuration may be accomplished by software, and the lifetime of the configured cluster memory may be the period during which the cluster executes a job (such as a single job). According to different embodiments, the cluster communication method may be peer-to-peer communication between two clusters, or data broadcast among a plurality of clusters.

Specific embodiments of the present disclosure are described in detail with reference to the drawings below.

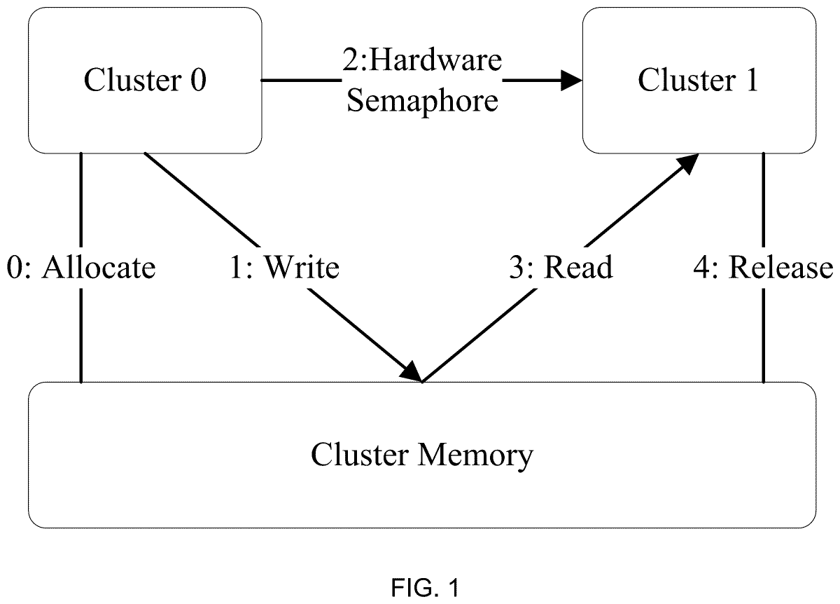

FIG. 1 is a schematic structural diagram of a board card 10 according to an embodiment of the present disclosure. It is understood that the structure and composition shown in FIG. 1 is merely an example and is not intended to limit the scheme of the present disclosure in any way.

As shown in FIG. 1, the board card 10 may include a chip 101, which may be an SoC (system on chip). In an implementation scenario, the board card 10 may be integrated with one or more combined processing apparatuses. The combined processing apparatus may be an artificial intelligence computing unit used to support various types of deep learning and machine learning algorithms to meet the intelligent processing requirements in complex scenarios in the fields of computer vision, speech, natural language processing, data mining, and the like. In particular, the combined processing apparatus may support the extensive application of deep learning technology in the field of cloud intelligence. A prominent feature of cloud intelligence application is the large amount of input data, which has high requirements on the storage capacity and computing power of a platform. The board card 10 of this embodiment is suitable for the cloud intelligence application, with huge off-chip storage, huge on-chip storage, and powerful computing capacity.

Further, as shown in the figure, the chip 101 is connected to an external apparatus 103 through an external interface apparatus 102. Depending on the application scenario, the external apparatus 103 may be, for example, a server, a computer, a camera, a monitor, a mouse, a keyboard, a network card, or a WIFI interface. To-be-processed data may be transferred from the external apparatus 103 to the chip 101 through the external interface apparatus 102. A computation result of the chip 101 may also be transferred by the external interface apparatus 102 back to the external apparatus 103. According to different application scenarios, the external interface apparatus 102 may have different interface forms, such as a PCIe (peripheral component interconnect express) interface.

The board card 10 may further include a memory 104 used for storing data, which includes one or a plurality of storage units 105. The memory 104 may connect to and transfer data to a control component 106 and the chip 101 through a bus. The control component 106 in the board card 10 may be configured to regulate and control a state of the chip 101. As such, in an application scenario, the control component 106 may include an MCU (Micro Controller Unit).

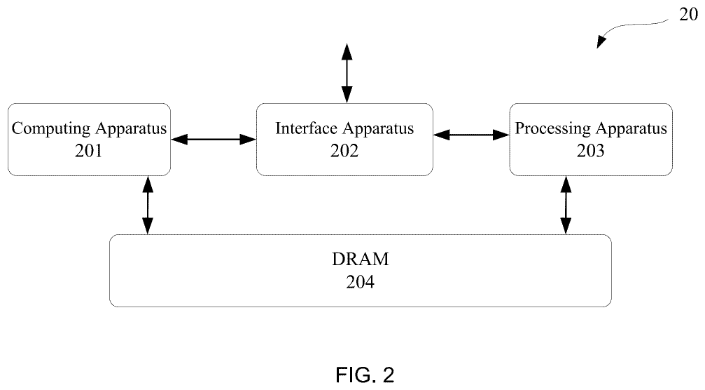

FIG. 2 is a structural diagram of a combined processing apparatus in the chip 101 according to an embodiment of the present disclosure. As shown in FIG. 2, the combined processing apparatus 20 may include a computing apparatus 201, an interface apparatus 202, a processing apparatus 203, and a DRAM (Dynamic Random Access Memory) 204.

The computing apparatus 201 is configured to perform user-specified operations and is primarily implemented as a single-core artificial intelligence processor or a multi-core artificial intelligence processor. In some operations, the computing apparatus 201 is configured to perform a deep learning computation or a machine learning computation. The computing apparatus 201 may interact with the processing apparatus 203 through the interface apparatus 202 to jointly complete the user-specified operations.

The interface apparatus 202 may be used to transfer data and control instructions between the computing apparatus 201 and the processing apparatus 203. For example, the computing apparatus 201 may acquire input data from the processing apparatus 203 via the interface apparatus 202 and write the input data to an on-chip storage apparatus of the computing apparatus 201. Further, the computing apparatus 201 may acquire the control instructions from the processing apparatus 203 via the interface apparatus 202 and write the control instructions to an on-chip control cache of the computing apparatus 201. Alternatively or optionally, the interface apparatus 202 may further read data in the storage apparatus of the computing apparatus 201 and then transfer the data to the processing apparatus 203.

The processing apparatus 203 serves as a general-purpose processing apparatus, and performs basic controls that include, but are not limited to, moving data, starting and/or stopping of the computing apparatus 201. According to different implementations, the processing apparatus 203 may be one or more types of processors, including a CPU (central processing unit), a GPU (graphics processing unit), or other general-purpose and/or special-purpose processors. These processors include but are not limited to a DSP (digital signal processor), an ASIC (application specific integrated circuit), an FPGA (field-programmable gate array), or other programmable logic devices, discrete gate or transistor logic devices, discrete hardware components, and the like. The number of the processors may be determined according to actual requirements. As described above, with respect to the computing apparatus 201 of the present disclosure only, the computing apparatus 201 of the present disclosure may be viewed as having a single-core structure or an isomorphic multi-core structure. However, when the computing apparatus 201 and the processing apparatus 203 are considered together, both the computing apparatus 201 and the processing apparatus 203 may be viewed as forming a heterogeneous multi-core structure.

The DRAM 204 may be used for storing to-be-processed data, and may be a DDR (Double Data Rate) memory with a size of 16G or more than 16G generally. The DRAM 204 is used for storing data of the computing apparatus 201 and/or the processing apparatus 203.

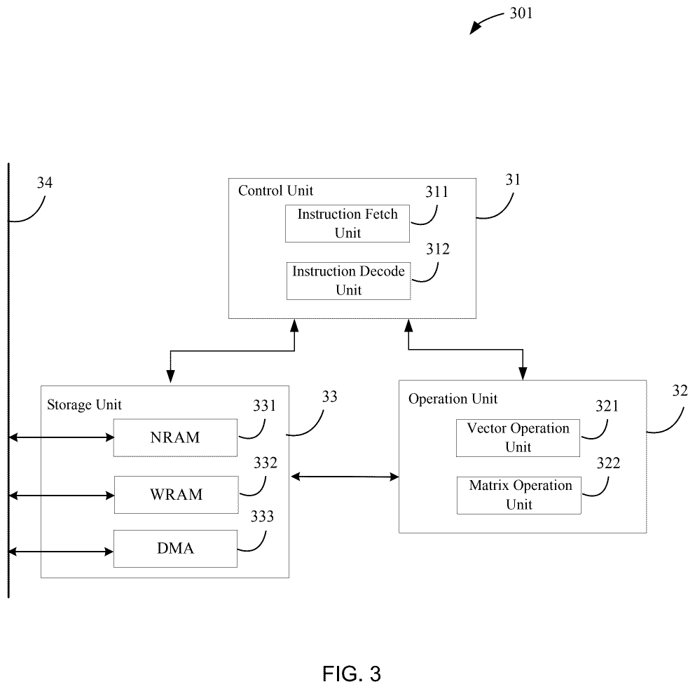

FIG. 3 is a schematic diagram of an internal structure of the computing apparatus 201 when it is a single-core computing apparatus. A single-core computing apparatus 301 is configured to process input data involving computer vision, speech, natural language, data mining, and the like. The single-core computing apparatus 301 includes three main units, which are a control unit 31, an operation unit 32, and a storage unit 33.

The control unit 31 is configured to coordinate and control the work of the operation unit 32 and the storage unit 33 to finish a deep learning job. The control unit 31 includes an IFU (instruction fetch unit) 311 and an IDU (instruction decode unit) 312. The instruction fetch unit 311 is configured to acquire an instruction from the processing apparatus 203. The instruction decode unit 312 is configured to decode the instruction acquired and send a decoding result as control information to the operation unit 32 and the storage unit 33.

The operation unit 32 includes a vector operation unit 321 and a matrix operation unit 322. The vector operation unit 321 is used to perform a vector operation, and may support complex operations such as vector multiplication, addition, and nonlinear transformation. The matrix operation unit 322 is responsible for the core computation of the deep learning algorithm, i.e., matrix multiplication and convolution. The storage unit 33 is used to store or move relevant data and includes an NRAM (Neuron RAM) 331, a WRAM (Weight RAM) 332, and a DMA (Direct Memory Access) 333. In an application scenario, the NRAM 331 is used to store an input neuron, an output neuron and an intermediate result after computation; the WRAM 332 is used to store a convolution kernel of a deep learning network, i.e., a weight; and the DMA 333 is connected to the DRAM 204 through a bus 34, responsible for data transfer between the single-core computing apparatus 301 and the DRAM 204.

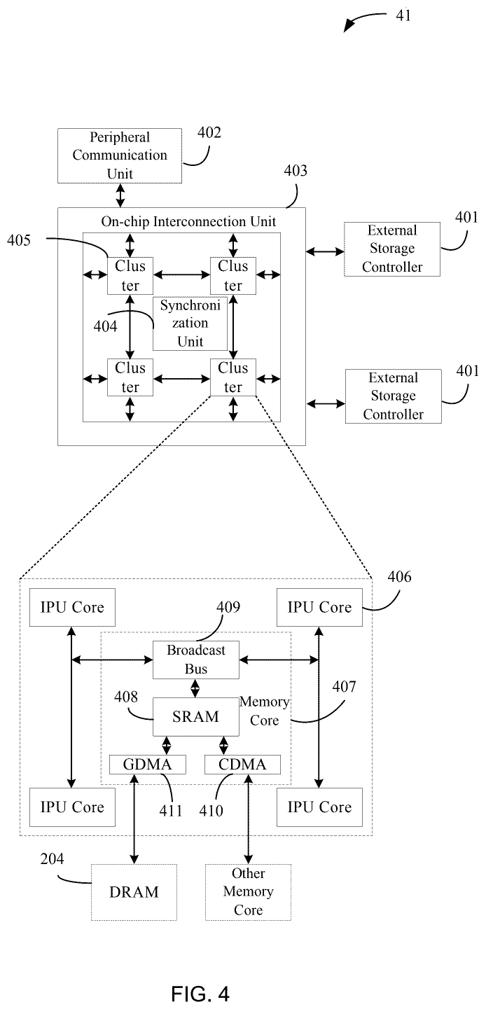

FIG. 4 is a schematic diagram of an internal structure of the computing apparatus 201 when it is a multi-core computing apparatus. A multi-core computing apparatus 41 is designed in a hierarchical structure. The multi-core computing apparatus 41 serves as an SoC, which includes at least one cluster according to the present disclosure, where each cluster further includes a plurality of processor cores. In other words, the multi-core computing apparatus 41 is composed of an SoC (System on Chip)-cluster-processor core hierarchy. In terms of the SoC hierarchy, as shown in FIG. 4, the multi-core computing apparatus 41 includes an external storage controller 401, a peripheral communication unit 402, an on-chip interconnection unit 403, a synchronization unit 404, and a plurality of clusters 405.

There may be a plurality of external storage controllers 401 (two of which are exemplarily shown in the figure) which are configured to access an external storage apparatus in response to an access request from processor cores, i.e., an off-chip memory (such as the DRAM 204 in the FIG. 2) in the context of the present disclosure, so as to read data off the chip or write the data.

The peripheral communication unit 402 is configured to receive a control signal from the processing apparatus 203 through the interface apparatus 202 to start the computing apparatus 201 to execute a job. The peripheral communication unit 402 is configured to receive a control signal from the processing apparatus 203 through the interface apparatus 202 to start the computing apparatus 201 to execute a job. The on-chip interconnection unit 403 connects the external storage controller 401, the peripheral communication unit 402, and the plurality of clusters 405, and is used for transferring data and the control signal among the units. The synchronization unit 404 is a GBC (Global Barrier Controller), and is used to coordinate the work progress of each cluster to ensure the synchronization of information. The plurality of clusters 405 of the present disclosure are the computing cores of the multi-core computing apparatus 41. Although four clusters are illustrated exemplarily in FIG. 4, with the development of hardware, the multi-core computing apparatus 41 of the present disclosure may also include 8, 16, 64, or even more clusters 405. In an application scenario, the clusters 405 are configured to efficiently execute deep learning algorithms.

In terms of the cluster hierarchy, as shown in FIG. 4, each cluster 405 may include a plurality of processor cores (IPU (Intelligent Processing Unit) cores) 406 and a memory core (MEM core) 407, for example, each cluster 405 may include a cache (such as an LLC) as described in the context of the present disclosure.

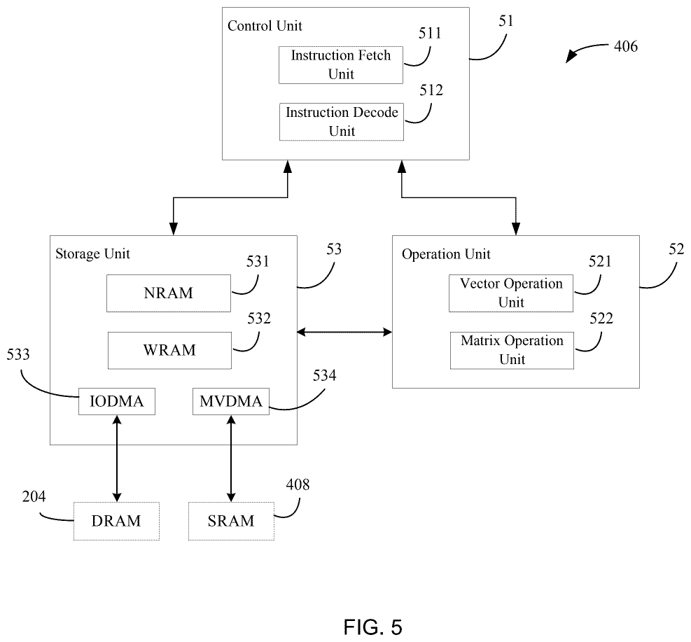

Four processor cores 406 are exemplarily illustrated in the figure. The present disclosure does not limit the number of processor cores 406, and an internal architecture of a processor core 406 is illustrated in FIG. 5. Each processor core 406 is similar to the single-core computing apparatus 301 shown in FIG. 3, and also includes three main units: a control unit 51, an operation unit 52 and a storage unit 53. Functions and structures of the control unit 51, the operation unit 52 and the storage unit 53 are generally the same as those of the control unit 31, the operation unit 32 and the storage unit 33, and will not be repeated herein. It should be noted that the storage unit 53 includes an IODMA (input/output direct memory access) 533 and an MVDMA (move direct memory access) 534. The IODMA 533 controls memory access of an NRAM 531/WRAM 532 and the DRAM 204 through a broadcast bus 409; the MVDMA 534 is used to control memory access of the NRAM 531/WRAM 532 and a storage unit (SRAM) 408.

Back to FIG. 4, the memory core 407 is primarily used for storage and communication; in other words, the memory core 407 is primarily used to store shared data or intermediate results among the processor cores 406 and execute communication between the clusters 405 and the DRAM 204, communication between each cluster 405 and each other cluster 405, and communication between each processor core 406 and each other processor core 406. In other embodiments, the memory core 407 may have the ability to perform a scalar operation, and is used to perform the scalar operation.

The memory core 407 may include an SRAM (Static Random-Access Memory), the broadcast bus 409, a CDMA (Cluster Direct Memory Access) 410 and a GDMA (Global Direct Memory Access) 411. In an application scenario, the SRAM 408 may assume the role of a high-performance data transit station. As a result, data reused between different processor cores 406 in the same cluster 405 may not be obtained from the DRAM 204 through the processor cores 406, but transferred through the SRAM 408 in the processor cores 406. Further, the memory core 407 is only required to quickly distribute the reused data from the SRAM 408 to a plurality of processor cores 406, which may improve the communication efficiency between the processor cores 811 and significantly reduce the on-chip and off-chip input/output access.

The broadcast bus 409, the CDMA 410, and the GDMA 411 are used to perform the communication among the processor cores 406, the communication among the clusters 405, and the data transmission between the clusters 405 and the DRAM 204, respectively, which will be described separately below.

The broadcast bus 409 is used to complete high-speed communication among the processor cores 406 in the clusters 405. The broadcast bus 409 of the embodiment supports inter-core communication including unicast, multicast, and broadcast. The unicast refers to peer-to-peer (such as a single processor core to a single processor core) data transmission; the multicast refers to a communication mode in which a piece of data is transferred from the SRAM 408 to certain processor cores 406; and the broadcast refers to a communication mode in which a piece of data is transferred from the SRAM 408 to all processor cores 406. The broadcast is a special case of the multicast.

The CDMA 410 is used for controlling memory access of the SRAM 408 among different clusters 405 in the same computing apparatus 201. The GDMA 411 works in conjunction with the external storage controller 401 to control the access from the SRAM 408 to the DRAM 204 in the clusters 405, or to read data from the DRAM 204 to the SRAM 408. From the above description, the communication between the DRAM 204 and the NRAM 531 or the WRAM 532 may be implemented through two manners. A first manner is to directly communicate the DRAM 204 with the NRAM 431 or the WRAM 432 through the IODAM 433. A second manner is to transfer the data between the DRAM 204 and the SRAM 408 through the GDMA 411 first, and then to transfer the data between the SRAM 408 and the NRAM 431 or the WRAM 432 through the MVDMA 534. Although the second manner may require more components and longer data streams, in fact, in some embodiments, the bandwidth of the second manner is much greater than that of the first manner. Therefore, the communication between the DRAM 204 and the NRAM 531 or the WRAM 532 may be more efficient through the second manner. It can be understood that the data transmission methods described herein are only exemplary, and those skilled in the art may flexibly choose and apply various data transmission methods according to the specific arrangement of hardware in accordance with the teachings of the present disclosure.

In other embodiments, a function of the GDMA 411 and a function of the IODMA 533 may be integrated in the same component. For the sake of description, the GDMA 411 and the IODMA 533 are viewed as different components in the present disclosure. For those skilled in the art, as long as functions and technical effects realized by components are similar to those of the present disclosure, the components shall fall within the scope of protection of the present disclosure. Further, the function of GDMA 411, the function of IODMA 533, a function of CDMA 410, and a function of MVDMA 534 may also be implemented by the same component.

The hardware architecture and its internal structure are described in detail in combination with FIG. 1-FIG. 5. It should be understood that the above description is exemplary rather than restrictive. According to different application scenarios and hardware specifications, those skilled in the art may also change the board card and its internal structure of the present disclosure, and these changes still fall within the scope of protection of the present disclosure. Taking the aforementioned CDMA as an example, which is used for different cluster access to the SRAM (or achieving communication via the SRAM), it has different applications or alternative methods depending on an application scenario. For example, taking the SoC scheme in the present disclosure as an example, since communication among clusters is achieved using the LLC in the present disclosure, the CDMA is not required to be used in the SoC system of the present disclosure. Alternatively, the CDMA may also be included in the SoC of the present disclosure as an alternative way of communication among clusters. The following will provide a detailed description of the SoC scheme of the present disclosure.

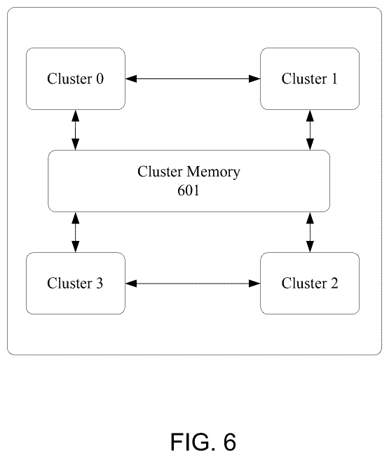

FIG. 6 is an architecture diagram of an SoC according to the present disclosure. It is understandable that the SoC shown in FIG. 6 is a simplification of the SoCs shown in FIG. 1-FIG. 5, with the aim of emphasizing and highlighting the key points and essence of the scheme of the present disclosure, and does not limit the aforementioned SoC in the present disclosure in any way. Based on this, the detailed descriptions regarding FIG. 1 to FIG. 5 also apply to the SoC shown in FIG. 6 and are not be repeated herein for the sake of brevity.

As shown in FIG. 6, the SoC may include a cluster memory 601 and a plurality of clusters, such as a cluster 0 to a cluster 3. In the scheme of the present disclosure, the cluster memory 601 may be partial storage space divided (or allocated) from a cache (such as an LLC) to be used for data transmission between any one or more clusters from the cluster 0 to the cluster 3.

In an implementation scenario, the aforementioned partial storage space and its lifetime may be allocated based on a job to be executed by the cluster, and may be specifically set through software. For example, the partial storage space is visible to upper-level software operators, who may directly configure and manage the partial storage space, and divide and configure attributes of the partial storage space based on the job to be executed by the cluster. Preferably, the size and lifetime of the cluster memory may be set at the granularity of a single job to be executed. In an implementation scenario, the preceding allocation operation has no effect on data previously stored in the cluster memory. In other words, the data previously stored in the storage space of the cluster memory will not be emptied as a result of the allocation operation, or dirty data will not be written back to the off-chip memory (such as a DRAM). Therefore, it may be understood that the allocation operation of the present disclosure is only to reserve partial storage space in the cache in advance, but not to actually occupy the partial storage space at the same time of allocation. By adopting the allocation operation, the scheme the present disclosure makes the use of the cache more flexible and efficient, avoiding the waste of available storage space in the SoC.

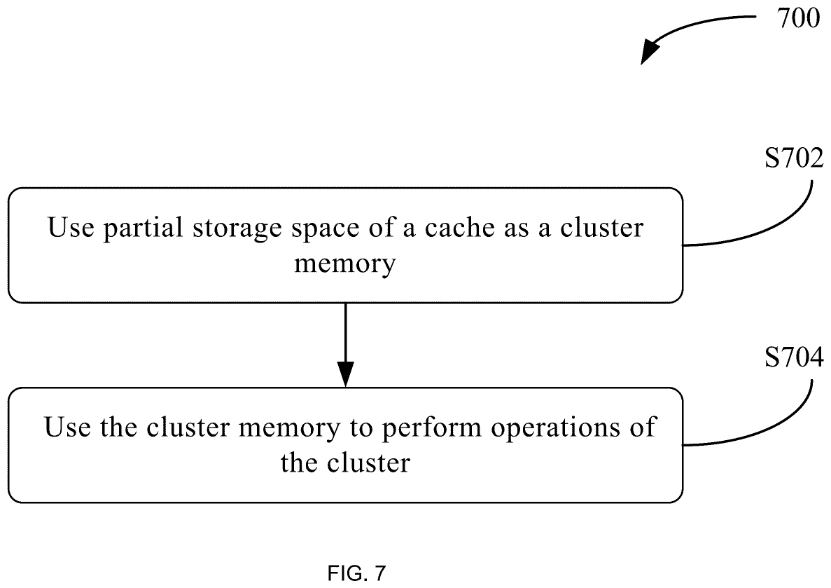

FIG. 7 is a flowchart illustrating a method 700 for the SoC according to an embodiment of the present disclosure. It may be understood that the method 700 may be used for the SoC described above in conjunction with FIG. 1-FIG. 6. Therefore, for the sake of brevity, only a simple description of the SoC will be provided below without a detailed description.

As shown in FIG. 7, at a step S702, partial storage space of the cache is used as a cluster memory. As described, the cache may be a cache set inside a storage unit (such as the storage unit 53 in FIG. 5) of the SoC and interconnected with a plurality of clusters. In an implementation scenario, the cache may be an LLC, and each cluster may include a plurality of processor cores for performing computing operations. In an embodiment, the cache may contain a plurality of cachelines. In this case, the scheme of the present disclosure may use a specified number of cachelines in the cache as a cluster memory. In an embodiment, the number of cachelines used as the cluster memory may be set by users through software customization. In a scenario, the number of cachelines used as the cluster memory may be less than the total number of cachelines in the cache. In other words, the scheme of the present disclosure use only some, but not all, of the cachelines for use as the cluster memory.

To implement the use of partial storage space as the cluster memory, in an embodiment, an allocation instruction to use partial storage space of the cache as the cluster memory may be added to an “instruction set” used for the SoC. Therefore, partial storage space may be allocated to be used as the cluster memory based on the aforementioned allocation instruction. In an implementation scenario, the aforementioned allocation instruction may include an opcode and at least one operand, where the opcode is used to identify the allocation operation, and the at least one operand may include a starting address and/or a size of the partial storage space.

After the allocation operation described above with respect to the allocation instruction is completed, in an embodiment, when the cluster memory is required to be used, a request to use the cluster memory to perform an operation of the cluster may be received. Subsequently, in response to the request, a write-back operation (for example, for dirty data) and an invalidation operation are performed on the cachelines of the partial storage space (i.e., the cluster memory) to the off-chip memory, in order to use the partial storage space to perform the operation of the cluster. In other words, the request operation may enable the cluster memory to be activated and used for the operations of the cluster. Conversely, after the allocation operation is performed and before the request is received, the scheme of the present disclosure still uses partial storage space for a caching operation of the cache rather than the operations of the cluster.

When the cluster memory is enabled, at a step S704, the cluster memory may be used to perform the operations of the cluster. In an embodiment, using the cluster memory to perform the operations of the cluster includes using the cluster memory for communication among clusters. In a scenario, the cluster memory may be utilized to implement peer-to-peer communication among clusters. Additionally, in another scenario, the cluster memory may be utilized to implement broadcast communication from one of a plurality of clusters to remaining clusters. During the peer-to-peer communication described earlier, the cluster memory may receive a write operation from a first cluster for written data and, in response to a read operation from a second cluster, send the written data to the second cluster.

In an embodiment, using the cluster memory to perform the operations of the cluster includes using the cluster memory to temporarily store data of the cluster. In this scenario, the data temporarily stored in the cluster memory is not required to be transferred to other clusters, and the cluster memory merely serves as a temporary memory for the cluster that stores the data By this way, the cluster memory may temporarily store various types of data in the cluster, such as intermediate results obtained by performing the operations of the cluster. Thereby, application scenarios and performance of the clusters may be enhanced to alleviate the requirement for data storage. In another embodiment, unlike the above-mentioned temporary storage of data for a single cluster, the cluster memory may also be used for sharing data among a plurality of clusters, allowing data of one cluster temporarily stored in the cluster memory to be shared with the other clusters.

In an embodiment, after the operations of the cluster are performed, the partial storage space may be used for the caching operation of the cache. In other words, at this point, the cluster memory may be used only for regular operations of the cache, rather than for the operations of the cluster. Accordingly, in an implementation scenario, a release instruction may be added to the instruction set, and the partial storage space may be released based on this release instruction. Corresponding to or similar to the foregoing allocation instruction, the release instruction may include an opcode and at least one operand, where the opcode is used to identify the release operation of the partial storage space, and the at least one operand may include a starting address and/or a size of the partial storage space to be released. It may be understood that in the embodiment of the present disclosure, by adding instructions for allocating and releasing the partial storage space in the cache to the instruction set, users of the upper-level software application may directly manage the partial storage space by performing operations, such as configuring the starting address and/or the size of the partial storage space. By this way, the partial storage space of the cache may be used as a Scratchpad memory. By using instructions to directly access and manage the partial storage space, efficient management and effective utilization of the cache may be achieved, which in turn significantly enhances the hardware utilization rate of the cache.

In an embodiment, the lifetime of the cluster memory may be the duration of the SoC performing a single job. In a scenario, the single job may be collaboratively executed by some or all of the clusters in a plurality of clusters. Specifically, during the execution of the single job, the cluster memory may be used to perform communication among some or all of the clusters. Subsequently, after the single job is executed, the partial storage space may be released according to the release instruction. By performing the allocation operation and release operation, the efficiency of the cache in the present disclosure is significantly improved. Further, due to the allocation of dedicated partial storage space for clusters, the communication among clusters in the SoC of the present disclosure becomes more efficient and stable, thereby enhancing the overall performance of the SoC.

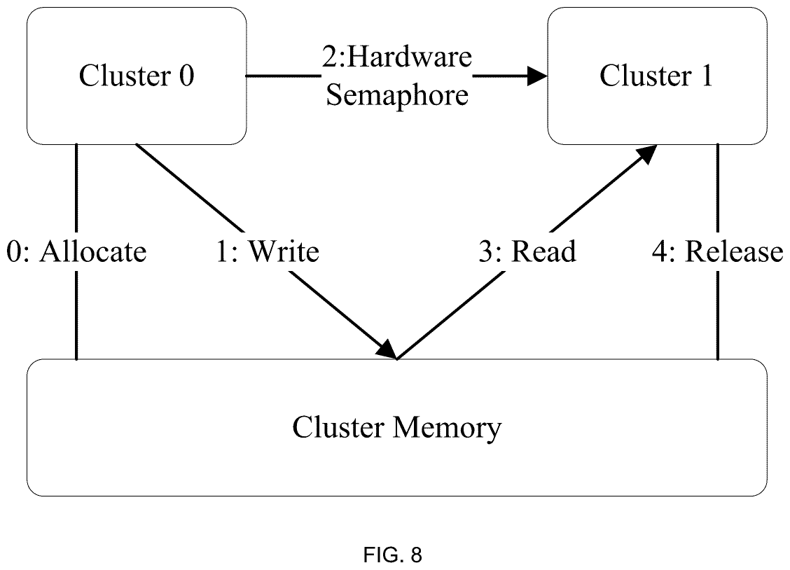

FIG. 8 is a schematic diagram illustrating communication among clusters according to an embodiment of the present disclosure. It may be understood that, for the purpose of clear illustration, only the peer-to-peer communication between the cluster 0 and the cluster 1 is illustrated here, while the disclosed scheme may be applied to communication among multiple clusters.

As shown in FIG. 8, at a step 0, a cluster 0 may perform the aforementioned allocation operation. For example, the allocation operation may be set by a programmer through a software program based on storage space required to execute a current job. In an implementation scenario, the aforementioned software program may be compiled by a compiler to obtain a corresponding allocation instruction. Based on this, the allocation instruction of the present disclosure may be a binary instruction executed on the SoC, thereby enabling the cluster 0 to obtain the cluster memory in the context of the present disclosure by executing the allocation instruction. During the lifetime of a job, the cluster memory is visible to all clusters of the SoC, and each cluster may perform reading and writing operations on the cluster memory using standard I/O instructions (such as a writing instruction for performing the writing operation and a reading instruction for performing the reading operation). For example, at a step 1, after performing the allocation operation, the cluster 0 may perform the writing operation to the cluster memory, specifically, the cluster 0 may write data involved in the current job into the cluster memory.

Once the data is written into the cluster memory, in one implementation scenario, to ensure the synchronization of operations among clusters, the cluster 0 may send a hardware semaphore (hsem) to the cluster 1. Upon receiving the hardware semaphore from the cluster 0, the cluster 1 is informed that the cluster 0 has written the data into the cluster memory. Consequently, the cluster 1 initiates the reading operation from the cluster memory, as shown at a step 3 in the figure. After reading the data written by the cluster 0 from the cluster memory, once the job has been completed, at a step 4, the cluster 1 may perform the release operation on the cluster memory. As previously described, the release operation here may be performed through the release instruction. By executing the release instruction, all data within a specified range in the cluster memory will be destroyed. Since the destruction operation may delete all involved data, it must be performed only after all accesses to the specified range in the cluster memory have been completed. In light of this, access operations for the specified range are required to be synchronized among clusters. In an implementation scenario, the present disclosure proposes that programmers manually insert a synchronization instruction through software to ensure that all access operations for the specified range are completed before the release operation, such as the release operation performed at the step 4.

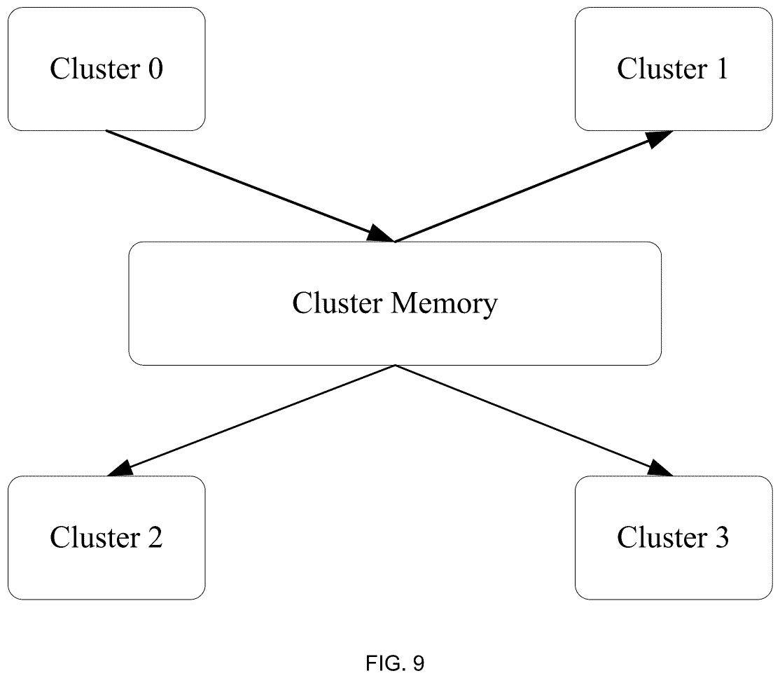

FIG. 9 is a schematic diagram illustrating broadcasting among clusters according to an embodiment of the present disclosure. As shown in FIG. 9, the SoC in the embodiment includes four clusters, namely a cluster 0 to a cluster 3, where the cluster 0 writes data into the cluster memory, and the cluster 1 to the cluster 3 read the data from the cluster memory, respectively, thereby completing a broadcast operation between the clusters. Similar to the peer-to-peer communication shown in FIG. 8, the cluster 0 may determine the size of the cluster memory through the allocation operation, and this designated area is visible to the cluster 1 to the cluster 3. Subsequently, the cluster 0 may notify the cluster 1 to the cluster 3 that the data has been written into the cluster memory based on the hardware semaphore. Afterward, the cluster 1 to the cluster 3 may read the data previously written by the cluster 0 from the cluster memory, thereby completing the broadcast operation. Once the reading operation is completed and the current job has been executed, the programmer may use a software instruction to designate one of the clusters from the cluster 1 to the cluster 3 to perform the release operation, thereby release the storage space of the cluster memory for use in, for example, regular caching operations of the cache.

The above description, in conjunction with the drawings, provides a detailed explanation of the scheme of the present disclosure. According to different application scenarios, the electronic device or apparatus of the present disclosure may include a server, a cloud server, a server cluster, a data processing apparatus, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household appliance may include a television, an air conditioner, a microwave oven, a refrigerator, an electric rice cooker, a humidifier, a washing machine, an electric lamp, a gas cooker, and a range hood; and the medical device may include a nuclear magnetic resonance spectrometer, a B-ultrasonic scanner, and/or an electrocardiograma electronic device or apparatus of the present disclosure may be further applied to Internet, Internet of Things, data center, energy, transportation, public management, manufacturing, education, power grid, telecommunications, finance, retail, construction sites, medical, and other fields.

Further, the electronic device or apparatus of the present disclosure may be used in application scenarios including cloud, edge, and terminal related to artificial intelligence, big data, and/or cloud computing. In one or a plurality of embodiments, according to the solution of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or a plurality of embodiments, hardware information of the cloud device is compatible with that of the terminal device and/or the edge device. As such, according to the hardware information of the terminal device and/or the edge device, appropriate hardware resources may be matched from hardware resources of the cloud device to simulate hardware resources of the terminal device and/or the edge device, so as to complete unified management, scheduling, and collaborative work of terminal-cloud integration or cloud-edge-terminal integration.

It is required to be explained that for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be executed in other orders or simultaneously. Further, those skilled in the art may understand that the embodiments described in the present disclosure may be regarded as optional embodiments; in other words, actions and modules involved thereof are not necessarily required for the implementation of a certain solution or some solutions of the present disclosure. Additionally, according to different solutions, descriptions of some embodiments of the present disclosure have their own emphases. In view of this, those skilled in the art may understand that for parts that are not described in detail in a certain embodiment of the present disclosure, reference may be made to related descriptions in other embodiments.

For specific implementations, according to the present disclosure and under the teaching of the present disclosure, those skilled in the art may understand that several embodiments disclosed in the present disclosure may be implemented through other methods that are not disclosed in the present disclosure. For example, for units in the electronic device or apparatus embodiment mentioned above, the present disclosure divides the units on the basis of considering logical functions, but there may be other division methods during actual implementations. For another example, a plurality of units or components may be combined or integrated into another system, or some features or functions in the units or components may be selectively disabled. In terms of a connection between different units or components, the connection discussed above in combination with drawings may be direct or indirect coupling between the units or components. In some scenarios, the aforementioned direct or indirect coupling relates to a communication connection using an interface, where the communication interface may support electrical, optical, acoustic, magnetic, or other forms of signal transmission.

In the present disclosure, units described as separate components may or may not be physically separated. Components shown as units may or may not be physical units. The aforementioned components or units may be located in the same position or distributed to a plurality of network units. Additionally, according to actual requirements, some or all of the units may be selected to achieve purposes of the solution described in embodiments of the present disclosure. Additionally, in some scenarios, the plurality of units in the embodiments of the present disclosure may be integrated into one unit, or each of the units may be physically separated.

In some implementation scenarios, the aforementioned integrated unit may be implemented in the form of a software program unit. If the integrated unit is implemented in the form of the software program unit and sold or used as an independent product, the integrated unit may be stored in a computer-readable memory. Based on such understanding, if the solution of the present disclosure is embodied in the form of a software product (such as a computer-readable storage medium), the software product may be stored in a memory, and the software product may include several instructions used to enable a computer device (such as a personal computer, a server, or a network device, and the like) to perform part or all of steps of the method of the embodiments of the present disclosure. The foregoing memory may include but is not limited to an USB, a flash disk, an ROM (“Read Only Memory), an RAM (“Random Access Memory), a mobile hard disk, a magnetic disk, or an optical disc, and other media that may store a program code.

In some other implementation scenarios, the aforementioned integrated unit may be implemented in the form of hardware. The hardware may be a specific hardware circuit, which may include a digital circuit and/or an analog circuit. A physical implementation of a hardware structure of the circuit may include but is not limited to a physical component, and the physical component may include but is not limited to a transistor, or a memristor, and the like. In view of this, various apparatuses described in the present disclosure (such as the computing apparatus or other processing apparatus) may be implemented by an appropriate hardware processor, such as a CPU, a GPU, a FPGA, a DSP, and an ASIC. Further, the aforementioned storage unit or storage apparatus may be any appropriate storage medium (including a magnetic storage medium or a magneto-optical storage medium, and the like), such as an RRAM (Resistive Random Access Memory), a DRAM (Dynamic Random Access Memory), an SRAM (Static Random Access Memory), an EDRAM (Enhanced Dynamic Random Access Memory), an HBM (High Bandwidth Memory), an HMC (Hybrid Memory Cube), the ROM, and the RAM, and the like.

The foregoing may be better understood according to following articles:
A1. A method used for the SoC, where the SoC includes at least a plurality of clusters for performing operations and a cache interconnected with the plurality of clusters, where each cluster includes a plurality of processor cores for performing the operations, where the method includes:
   using partial storage space of the cache as a cluster memory; and
   using the cluster memory to perform operations of the cluster.
A2. The method of A1, where using the cluster memory to perform the operations of the cluster includes using the cluster memory for communication among clusters.
A3. The method of A2, where using the cluster memory for communication among clusters includes:
   using the cluster memory to implement peer-to-peer communication among clusters; or
   using the cluster memory to implement broadcast communication from one of a plurality of clusters to remaining clusters.
A4. The method of A3, where using the cluster memory to implement peer-to-peer communication among clusters includes:
   receiving a write operation from a first cluster for written data; and
   sending the written data to a second cluster in response to a read operation from the second cluster.
A5. The method of A1, where using the cluster memory to perform the operations of the cluster includes using the cluster memory to temporarily store data of the cluster.
A6. The method of A1, where using the cluster memory to perform the operations of the cluster includes using the cluster memory for sharing data among a plurality of clusters, allowing data of one cluster temporarily stored in the cluster memory to be shared with the other clusters.
A7. The method of A1, before using the cluster memory to perform the operations of the cluster, further including:
   receiving a request to use the cluster memory to perform the operations of the cluster; and
   performing a write-back operation and an invalidation operation on, in response to the request, cachelines of the partial storage space to an off-chip memory to use the partial storage space to perform the operations of the cluster.
A8. The method of A7, where before receiving the request and/or after completing the operations of the cluster, the method includes using the partial storage space for a caching operation of the cache.
A9. The method of A1, further including:
   receiving an allocation instruction to use the partial storage space as the cluster memory; and
   allocating the partial storage space to be used as the cluster memory based on the allocation instruction, where
   the allocation instruction includes an opcode and at least one operand, where the opcode is used to identify an allocation operation, and the at least one operand includes a starting address and/or a size of the partial storage space.
A10. The method of A1 or A9, further including:
   receiving a release instruction to release the partial storage space; and
   release the partial storage space based on the release instruction, where
   the release instruction includes an opcode and at least one operand, where the opcode is used to identify a release operation, and the at least one operand includes a starting address and/or a size of the partial storage space to be released.
A11. The method of A10, where the operations of the cluster include executing a single job collaboratively by some or all of the clusters in a plurality of clusters, and the method includes:
   using the cluster memory, during the execution of the single job, to perform communication among some or all of the clusters; and
   releasing the partial storage space based on the release instruction after the single job is executed.
A12. An SoC, including:
   a plurality of clusters, where each cluster includes a plurality of processor cores for performing operations; and
   a cache interconnected with the plurality of processor cores and configured to
   use partial storage space as a cluster memory based on an allocation from the cluster, and
   use the cluster memory to perform operations of the cluster.
A13. The SoC of A12, where the cluster memory is used for broadcast communication among clusters or peer-to-peer communication among clusters.
A14. The SoC of A13, where during the peer-to-peer communication, the cluster memory is configured to
   receive a write operation from a first cluster for written data; and
   send the written data to a second cluster in response to a read operation from the second cluster.
A15. The SoC of A14, where the second cluster is configured to
   receive hardware semaphore from the first cluster; and
   perform the read operation on the cluster memory in response to the received hardware semaphore.
A16. The SoC of A12, where the cluster memory is configured to temporarily store data of the cluster.
A17. The SoC of A12, where the cluster memory is configured to share data among a plurality of clusters, allowing data of one cluster temporarily stored in the cluster memory to be shared with other clusters.
A18. The SoC of A12, where the cache is configured to
   receiving a request to use the cluster memory to perform the operations of the cluster; and
   in response to the request, perform a write-back operation and an invalidation operation on cachelines of the partial storage space to the off-chip memory, in order to use the partial storage space to perform the operations of the the cluster.
A19. The SoC of A18, where before receiving the request and/or after completing the operations of the cluster, the cache is configured to use the partial storage space for a caching operation of the cache.
A20. The SoC of A12, where the cluster memory is further configured to
receive an allocation instruction from the cluster to use the partial storage space as the cluster memory; and
allocate the partial storage space to be used as the cluster memory based on the allocation instruction, where the allocation instruction includes a starting address, a size, and/or an identification for identifying an allocation operation of the partial storage space.
A21. The SoC of A12 or A20, where the cluster memory is further configured to
   receive a release instruction from the cluster to release the partial storage space; and
   release the partial storage space based on the release instruction, where the release instruction includes a starting address, a size, and/or an identification for identifying a release operation of the partial storage space to be released.
A22. The SoC of A21, where the operations of the cluster include collaboratively by some or all of the clusters in a plurality of clusters, and during the execution of the single job, the cluster memory is set to be shared by some or all clusters to perform communication among the clusters; and the partial storage space is released based on the release instruction after the single job is executed.
A23. An integrated circuit device, including the SoC of any one of A12-A22.
A24. A board card, comprising the integrated circuit device of A23.
A25. A computing apparatus including the board card of the A24.

Although several embodiments of the present disclosure are shown and described, it is apparent to those skilled in the art that such embodiments are provided merely as examples. Those skilled in the art may conceive of many modifications, alterations, and alternatives without departing from the spirit and scope of the present disclosure. It should be understood that in the practice of the present disclosure, various alternatives may be employed in addition to the embodiments described herein. The appended claims are intended to define the scope of protection for the present disclosure and, therefore, cover equivalents or alternatives within the scope of these claims.

What is claimed:

1. A method used for an SoC (System on Chip), wherein the SoC comprises at least a plurality of clusters for performing operations and a cache interconnected with the plurality of clusters, wherein each cluster comprises a plurality of processor cores for performing the operations, wherein the method comprises:
using partial storage space of the cache as a cluster memory; and
using the cluster memory to perform operations of the cluster.

2. The method of claim 1, wherein using the cluster memory to perform the operations of the cluster includes using the cluster memory for communication among clusters.

3. The method of claim 2, wherein using the cluster memory for communication among clusters includes:
using the cluster memory to implement peer-to-peer communication among clusters; or
using the cluster memory to implement broadcast communication from one of a plurality of clusters to remaining clusters.

4. The method of claim 3, where using the cluster memory to implement peer-to-peer communication among clusters includes:
receiving a write operation from a first cluster for written data; and
sending the written data to a second cluster in response to a read operation from the second cluster.

5. The method of claim 1, wherein using the cluster memory to perform the operations of the cluster includes using the cluster memory to temporarily store data of the cluster.

6. The method claim 1, wherein using the cluster memory to perform the operations of the cluster includes using the cluster memory for sharing data among a plurality of clusters, allowing data of one cluster temporarily stored in the cluster memory to be shared with other clusters.

7. The method of claim 1, before using the cluster memory to perform the operations of the cluster, further comprising:
receiving a request to use the cluster memory to perform the operations of the cluster; and
performing a write-back operation and an invalidation operation on, in response to the request, cache lines of the partial storage space to an off-chip memory to use the partial storage space to perform the operations of the cluster.

8. The method of claim 7, wherein before receiving the request and/or after completing the operations of the cluster, the method comprises using the partial storage space for a caching operation of the cache.

9. The method of claim 1, further comprising:
receiving an allocation instruction to use the partial storage space as the cluster memory; and
allocating the partial storage space to be used as the cluster memory based on the allocation instruction, where the allocation instruction includes an opcode and at least one operand, wherein the opcode is used to identify an allocation operation, and the at least one operand includes a starting address and/or a size of the partial storage space.

10. The method of claim 1, further comprising:
receiving a release instruction to release the partial storage space; and
releasing the partial storage space based on the release instruction, wherein
the release instruction includes an opcode and at least one operand, wherein the opcode is used to identify a release operation, and the at least one operand includes a starting address and/or a size of the partial storage space to be released.

11. The method of claim 10, wherein the operations of the cluster include executing a single job collaboratively by some or all of the clusters in a plurality of clusters, and the method comprises:
using the cluster memory, during the execution of the single job, to perform communication among some or all of the clusters; and
releasing the partial storage space based on the release instruction after the single job is executed.

12. An SoC, comprising:
a plurality of clusters, wherein each cluster includes a plurality of processor cores for performing operations; and
a cache interconnected with the plurality of processor cores and configured to
use partial storage space as a cluster memory based on an allocation from the cluster, and
use the cluster memory to perform operations of the cluster.

13. The SoC of claim 12, wherein the cluster memory is used for broadcast communication among clusters or peer-to-peer communication among clusters.

14. The SoC of claim 13, wherein during the peer-to-peer communication, the cluster memory is configured to
receive a write operation from a first cluster for written data; and
send the written data to a second cluster in response to a read operation from the second cluster.

15. The SoC of claim 14, wherein the second cluster is configured to
Receive hardware semaphore from the first cluster; and
perform the read operation on the cluster memory in response to the received hardware semaphore.

16. The SoC of claim 12, wherein the cluster memory is configured to temporarily store data of the cluster.

17. The SoC of claim 12, wherein the cluster memory is configured to share data among a plurality of clusters, allowing data of one cluster temporarily stored in the cluster memory to be shared with other clusters.

18. The SoC of claim 12, wherein the cache is configured to
receiving a request to use the cluster memory to perform the operations of the cluster; and
perform a write-back operation and an invalidation operation on, in response to the request, cache lines of the partial storage space to an off-chip memory to use the partial storage space to perform the operations of the cluster.

19. The SoC of claim 18, wherein before receiving the request and/or after completing the operations of the cluster, the cache is configured to use the partial storage space for a caching operation of the cache.

20. The SoC of claim 12, wherein the cluster memory is further configured to
receive an allocation instruction from the cluster to use the partial storage space as the cluster memory;
allocate the partial storage space to be used as the cluster memory based on the allocation instruction, where the allocation instruction includes a starting address, a size, and/or an identification for identifying an allocation operation of the partial storage space;
receive a release instruction from the cluster to release the partial storage space; and
release the partial storage space based on the release instruction, wherein the release instruction includes a starting address, a size, and/or an identification for identifying a release operation of the partial storage space to be released.

21. (canceled)

22. (canceled)

23. (canceled)

24. (canceled)

25. (canceled)
